(19) United States
(12) Patent Application Publication
(10) Pub. No.: US 2006/0279531 A1
(43) Pub. Date: Dec. 14, 2006

(54) Physical interaction-responsive user interface

(76) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: Searete LLC, Suite 110, 1756 - 114th Ave. S.E., Bellevue, WA, 98004, US

(21) Appl. No.: 11/139,014

(22) Filed: May 27, 2005

Related U.S. Application Data
(63) Continuation-in-part of application No. 11/137,688, filed on May 25, 2005.

(51) Int. Cl. G09G 5/00

(52) U.S. Cl. 345/156

(57) ABSTRACT

In one aspect, a method related to a physical interaction-responsive user interface. In addition to the foregoing, other method and system and program product aspects are described in the claims, drawings, and text forming a part of the present application.

### RELATED APPLICATIONS

1. For purposes of the USPTO extra-statutory requirements, the present application constitutes a continuation in part of currently co-pending U.S. patent application entitled PHYSICAL INTERACTION-SENSITIVE USER INTERFACE, naming Edward K. Y. Jung; Royce A. Levien; Robert W. Lord, Mark A. Malamud; and John D. Rinaldo, Jr.; as inventors, USAN: To be Assigned, filed May 25, 2005.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### TECHNICAL FIELD

The present application relates, in general, to a physical interaction-responsive user interface.

### SUMMARY

In one aspect, a method related user input to a device includes but is not limited to providing at least one criterion for at least one aberrant user input; detecting the at least one aberrant user input at least partially in response to the at least one criterion; and providing an adaptive response at least partially in response to the at least one aberrant user input. In addition to the foregoing, other method aspects are described in the claims, drawings, and text forming a part of the present application.

In one aspect, a system related to user input to a device includes but is not limited to: circuitry for providing at least one criterion for at least one aberrant user input; circuitry for detecting the at least one aberrant user input at least partially in response to the at least one criterion; and circuitry for providing an adaptive response at least partially in response to the at least one aberrant user input. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for providing at least one criterion for at least one aberrant user input; one or more instructions for detecting the at least one aberrant user input at least partially in response to the at least one criterion; and one or more instructions for providing an adaptive response at least partially in response to the at least one aberrant user input. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIGS. 1A, 1B, and 1C depict implementations of an exemplary environment in which the methods and systems described herein may be represented;

FIG. 2 depicts a high-level logic flowchart of an operational process;

FIG. 3 illustrates several alternative implementations of the high-level logic flowchart of FIG. 2;

FIG. 4 illustrates several alternative implementations of the high-level logic flowchart of FIG. 2;

FIG. 5 shows several alternative implementations of the high-level logic flowchart of FIG. 2;

FIG. 6 shows several alternative implementations of the high-level logic flowchart of FIG. 2; and

FIG. 7 shows several alternative implementations of the high-level logic flowchart of FIG. 2.

The use of the same symbols in different drawings typically indicates similar or identical items.

### DETAILED DESCRIPTION

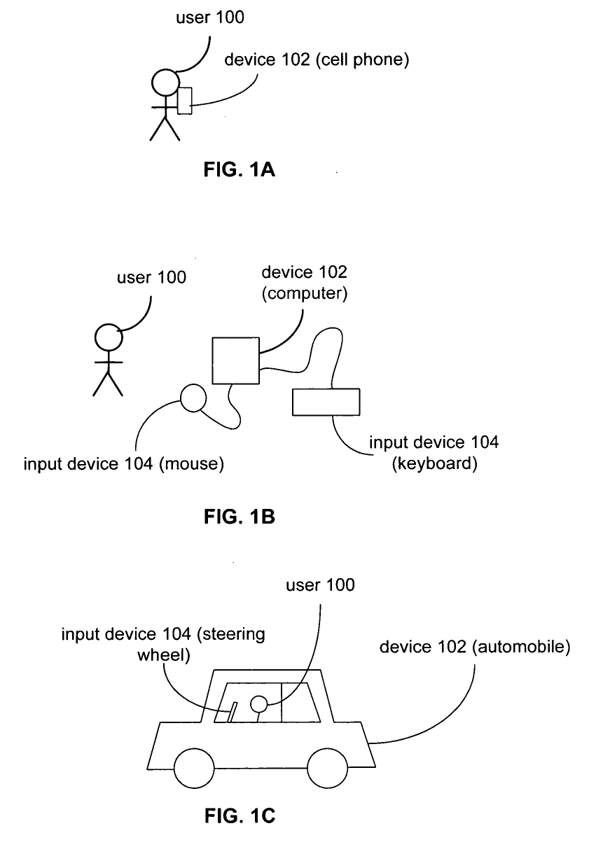

With reference to the figures, FIGS. 1A, 1B, and 1C depict implementations of an exemplary environment in which the methods and systems described herein may be represented. The user 100 is the user of devices 102. Device 102 may be any device that requires user input for its operation including, e.g., the illustrated devices (a cell phone, a computer, or an automobile). FIG. 1A shows the user 100 with device 102, a cell phone. FIG. 1B illustrates the user 100 with device 102, a computer, which has input devices 104, a mouse and a keyboard. FIG. 1C depicts the user 100 with device 102, an automobile, with an input device 104, a steering wheel. The devices 102 and the input devices 104 shown in FIGS. 1A, 1B, and 1C are representative and are not intended to be limiting.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

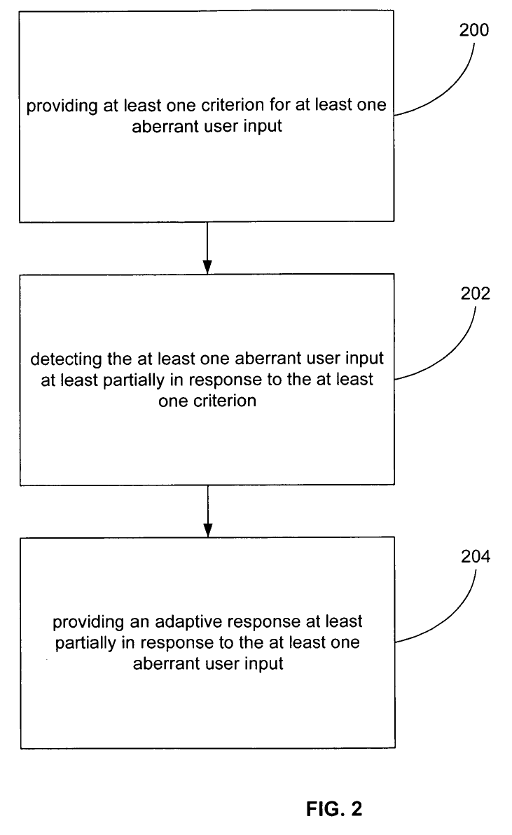

FIG. 2 depicts a high-level logic flowchart of various operational processes. Operation 200 shows providing at least one criterion for at least one aberrant user input. Operation 202 shows detecting the at least one aberrant user input at least partially in response to the at least one criterion. Operation 204 shows providing an adaptive response at least partially in response to the at least one aberrant user input.

As used herein, the term “aberrant user input” may include but is not limited to actions, events, and/or results that can be associated with one or more actions of the user 100 with reference to the device 102, the input devices 104, and/or the like, that deviate from normal and/or expected use of and/or interaction with device 102 features, features of the input devices 104, and/or the like. For instance, in one contemplated implementatation, monitoring logic internal to and/or associated with device 102, input device 104, and/or the like, monitors one or more usage patterns with respect to (a) mechanical inputs (e.g., monitors how hard/soft keys are pushed on a keyboard/keypad (e.g, on a computer and/or wireless device), monitors how hard/soft one or more mouse controls are manipulated, monitors average accelerations/decelerations of a device (e.g., of a wireless phone), monitors how controls (e.g., keys) are typically activated (e.g., typically large goups of keys are not jammed down at once), monitors how fast and/or how often icons, such as Graphic User Interface objects are moved around and/or accessed, etc.), and/or (b) sonic inputs (e.g., monitors how loud/soft a user's voice typically is, monitors voice stress, monitors sonic content (e.g., strong curse words), and/or (c) other user-type inputs. Once the monitoring agent has a baseline of what the system designer has designated “normal” user input patterns (e.g., those within one standard deviation about a mechanical, sonic, and/or other mean if statistical methods are used; and/or a fuzzy logic determination of normal in implementations where fuzzy logic may be utilized), actions, events, and/or results associated with one or more actions of the user 100 falling outside of what are deemed by the system designer as normal are deemed “aberrant.” In other implementations, rather than using a monitoring agent, device 102 and/or input devices 104 are preloaded with logic wherein what are deemed as normal mechanical and/or normal sonic inputs are preset, and thresholded variations about such preset inputs are deemed aberrant (e.g., above one or more preset threshold pressures and/or preset threshold volumes and/or threshold speech contents).

In addition and/or in the alternative to the foregoing, the term aberrant user input, as used herein, can also include but is not limited to those situations in which a user's actions do not employ user interface affordances. For example, a phone provides affordances for entering characters and/or invoking functions by pressing specific keys or combinations of keys. Smashing the keypad ignores these affordances, and hence the detectable effects of such smashing, in some implementations, would give rise to a detection of “aberrant user input.” As another example, the Roomba case is illustrative (“Roomba” might be a trademark/trade name associated with a type of floor-cleaning robot manufactured by Irobot, which is located on the web at: http://www.irobot.com). This floor sweeping robot is structured such that it changes direction if it runs into a wall with its bumpers. Hence, if one were to kick the Roomba on its bumpers, where the force of the kick was at or under that expected by the Roomba in normal operation, in some implementations such a kick would typically not be interpreted as “aberrant user input”; however, if the force of the kick significantly exceeded that expected by the Roomba in the course of normal operations, in some implementations, the detectable effects of such a forceful kick would be interpreted as “aberrant user input.” Similarly, detectable actions, events, and/or results associated with hitting the robot with a fist, or kicking the robot elsewhere, in some implementations could also be interpreted as “aberrant user input,” dependent upon context.

Hence, those skilled in the art will be able to appreciate what is meant by “aberrant user input” by examining various inputs in the context of normal operations and/or one or more design criteria. For instance, outside the parameters of normal inputs (e.g., the hard kick above); characteristic of actions taken by frustrated humans (e.g., hitting, yelling, striking, throwing, repetition, nonsense combinations, twisting, breaking as described here and elsewhere herein); implausible or extreme uses of the input affordances/sensors (e.g., striking random sequences of three to five keys at a time in quick succession, or hitting a robot in the face), etc. Specific examples of “aberrant user input” typically associated with actions taken by frustrated humans could include detectable actions, events, and/or results associated with a person smashing a fist on the dashboard of a car, and/or detectable actions, events, and/or results associated with a person hitting a television set when reception is poor.

The exemplary environment of FIG. 1 can serve to illustrate examples of operations described herein. In one example at least partially illustrative of operation 200, the user 100 expresses frustration or anger with some aspect of his use of the device 102 (e.g., a graphic display not updating quickly) or the input device 104 (e.g., the device 102 apparently not accepting input via a mouse input device 104) by taking an action that does not make use of the device 102 features or the input devices 104 features as they are designed to be used (e.g., slapping a surface of a desktop computer device 102 or pounding an input device mouse 104 on a table top). Operation 200, providing at least one criterion for at least one aberrant user input, includes but is not limited to providing a criterion for an aberrant user input (e.g., tactile, such as a slap; or sonic, such as a shout). An aberrant user input may be defined in part by parameters that may include but are not limited to parameters that may include but are not necessarily limited to parameters defining impacts in terms of intensity and/or repetition characteristics, or parameters defining sonic inputs in terms of intensity, content, and/or characteristics. Operation 202, detecting the at least one aberrant user input at least partially in response to the at least one criterion, includes but is not necessarily limited to physically detecting an aberrant user input.

In one example at least partially illustrative of operation 204, providing an adaptive response at least partially in response to the at least one aberrant user input, operation 204 includes but is not necessarily limited to stopping an operation in progress, offering to assist the user, accepting user input to perform an emergency operation, notifying a non-user, and/or providing a record of actions taken as a result of the aberrant user input. Operation 204 may be performed with resources present within the physical confines of a device 102 or an input device 104, e.g., embedded hardware/software/firmware logic, and/or with resources to which the device 102 or the input device 104 is operably coupled, e.g., a wireless connection, hardware circuitry, and/or the Internet.

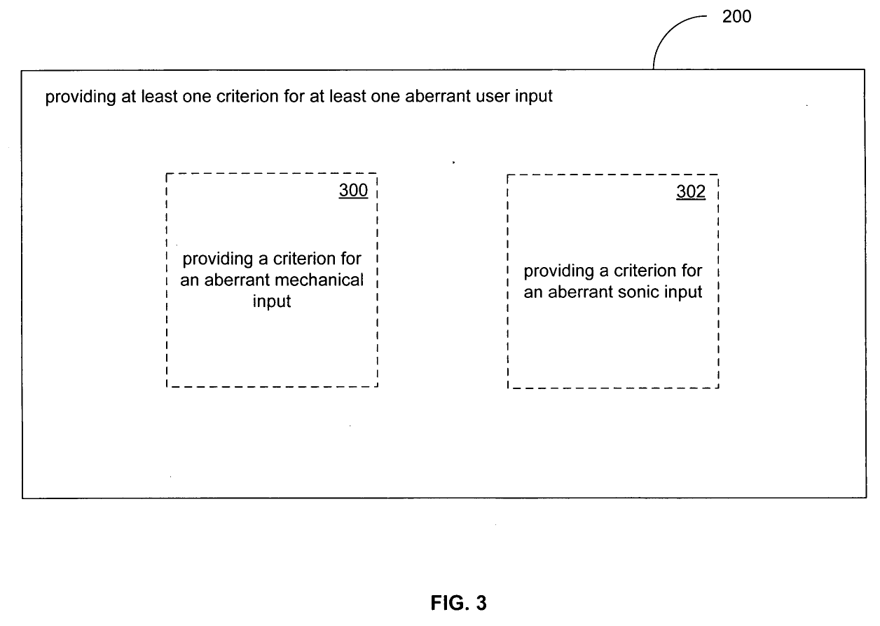

FIG. 3 illustrates alternate implementations of the high-level logic of flowchart of FIG. 2. Depicted is that, in various alternative implementations, operation 200—providing at least one criterion for at least one aberrant user input—may include operation 300 and/or an operation 302. Operation 300 depicts providing a criterion for an aberrant mechanical input (e.g., providing a criterion that defines an impact against a surface of the device 102 or the input device 104 with particular characteristics as an aberrant user input). Operation 302 depicts providing a criterion for an aberrant sonic input (e.g., providing a criterion that defines a shout at the device 102 or the input device 104 with particular characteristics, such as a detectable level of tension and/or the presence of pre-specified words, as an aberrant user input).

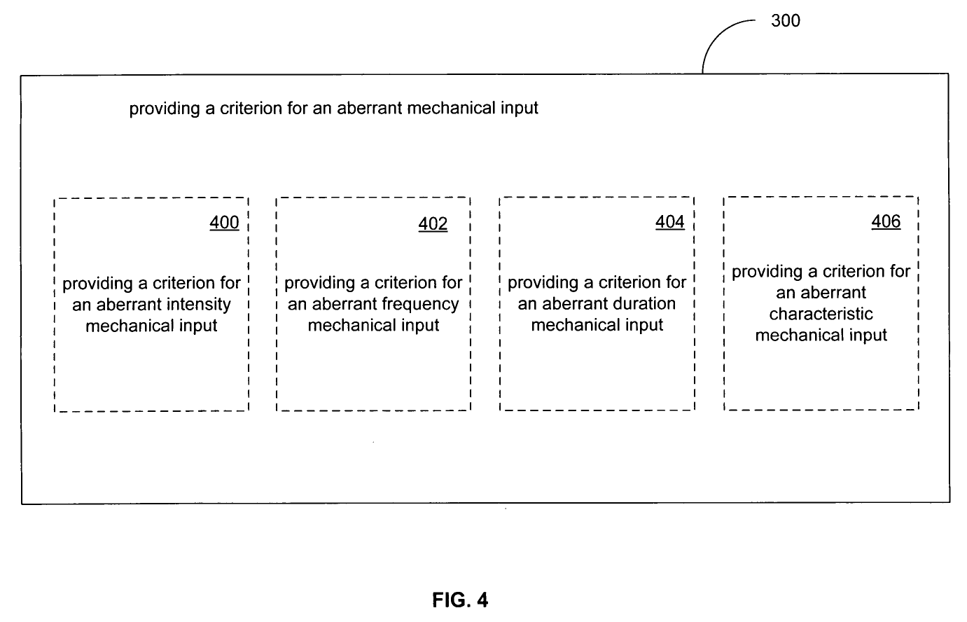

FIG. 4 illustrates alternate implementations of the high-level logic flowchart of FIG. 2. Depicted is that, in various alternative implementations, operation 300—providing a criterion for an aberrant mechanical input—may include operations 400, 402, 404, and/or 406. Operation 400 shows providing a criterion for an aberrant intensity mechanical input (e.g., providing a parameter defining as an aberrant user input an impact such as a slap or a kick by a user 100 to a device 102 and/or an input device 104 that is greater than a pre-specified intensity). Operation 402 shows providing a criterion for an aberrant frequency mechanical input (e.g., providing a parameter defining as an aberrant user input a repetitive action such as repeated slaps or kicks greater than a pre-specified number and/or frequency of repetitions by a user 100 to a device 102 and/or an input device 104). Operation 404 shows providing a criterion for an aberrant duration mechanical input (e.g., providing a parameter defining as an aberrant user input an action such as pounding or kicking performed by a user 100 on a device 102 and/or an input device 104 for at least a pre-specified period of time). Operation 406 shows providing a criterion for an aberrant characteristic mechanical input (e.g., providing a parameter defining as an aberrant user input an action such as squeezing performed by a user 100 on a device 102 and/or an input device 104 for at least a pre-specified period of time and/or at or above a pre-specified intensity).

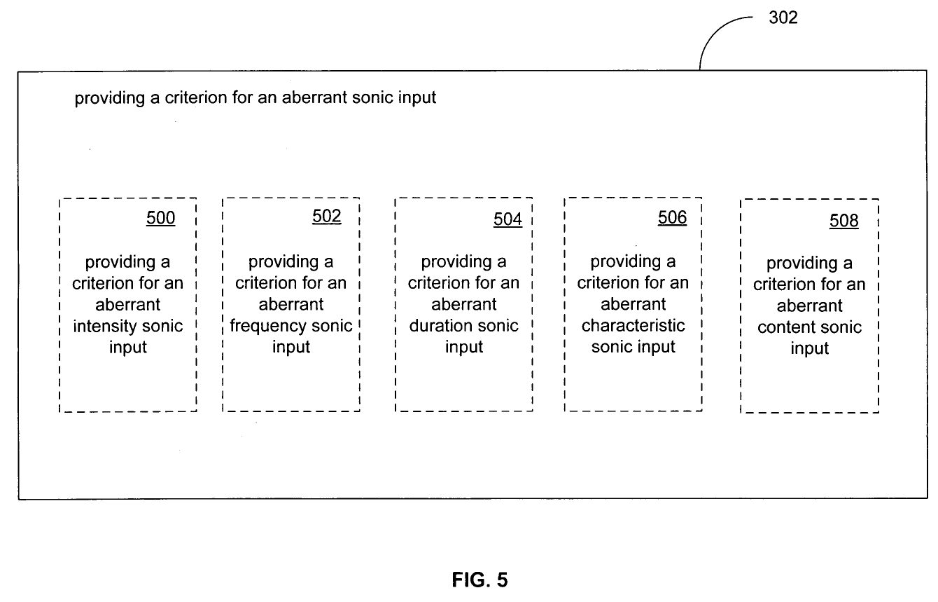

FIG. 5 illustrates alternate implementations of the high-level logic flowchart of FIG. 2. Depicted is that, in various alternative implementations, operation 302—providing a criterion for an aberrant sonic input—may include operations 500, 502, 504, 506, and/or 508. Operation 500 shows providing a criterion for an aberrant intensity sonic input (e.g., providing a parameter defining as an aberrant user input a vocal input such as a shout by a user 100 to a device 102 and/or an input device 104 that is greater than a pre-specified intensity). Operation 502 shows providing a criterion for an aberrant frequency sonic input (e.g., providing a parameter defining as an aberrant user input a repetitive action such as repeated shouts greater that a pre-specified number and/or frequency of repetitions by a user 100 to a device 102 and/or an input device 104). Operation 504 shows providing a criterion for an aberrant duration sonic input (e.g., providing a parameter defining as an aberrant user input an action such as shouting performed by a user 100 with reference to a device 102 and/or an input device 104 for at least a pre-specified period of time). Operation 506 shows providing a criterion for an aberrant characteristic sonic input (e.g., providing a parameter defining as an aberrant user input a detectable level of tension, at or above a pre-specified level, in the voice of the user 100 as she shouts at the device 102 and/or the input device 104). Operation 508 shows providing a criterion for an aberrant content sonic input (e.g., providing a parameter defining as an aberrant user input a presence of a pre-specified word and/or phrase, in the speaking of the user 100 as he speaks to the device 102 and/or the input device 104).

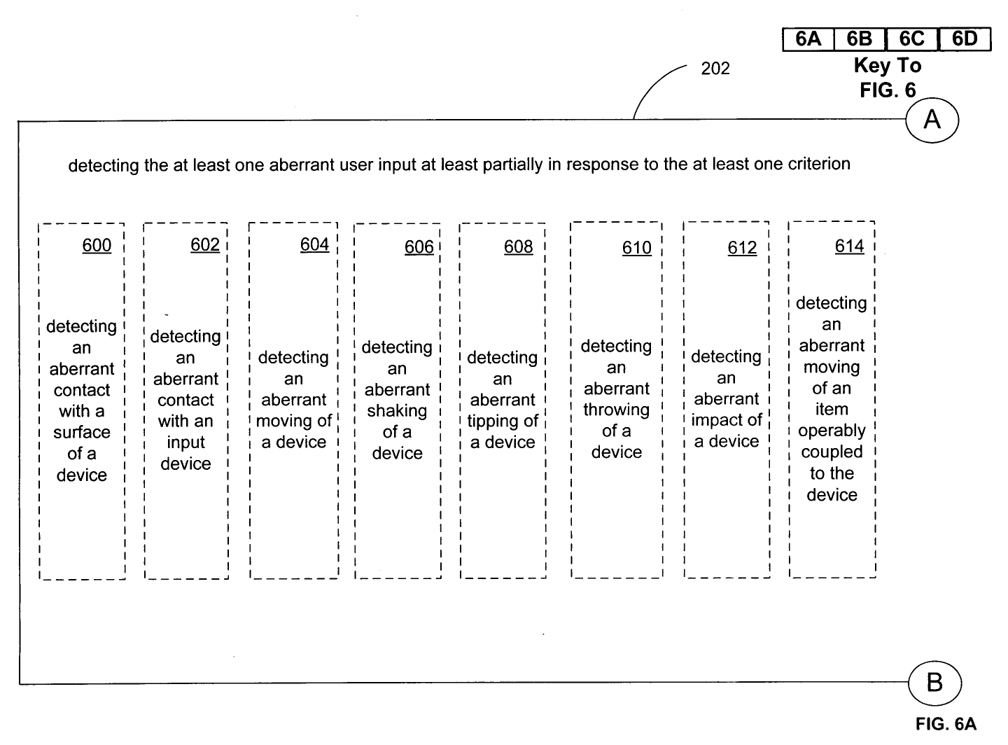

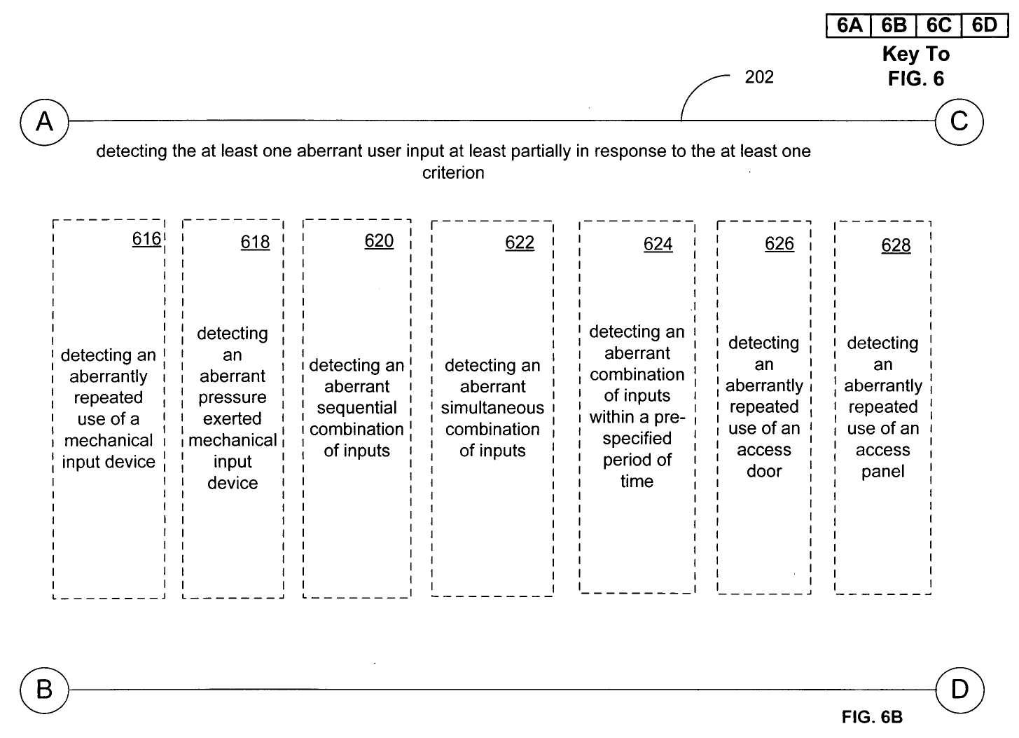

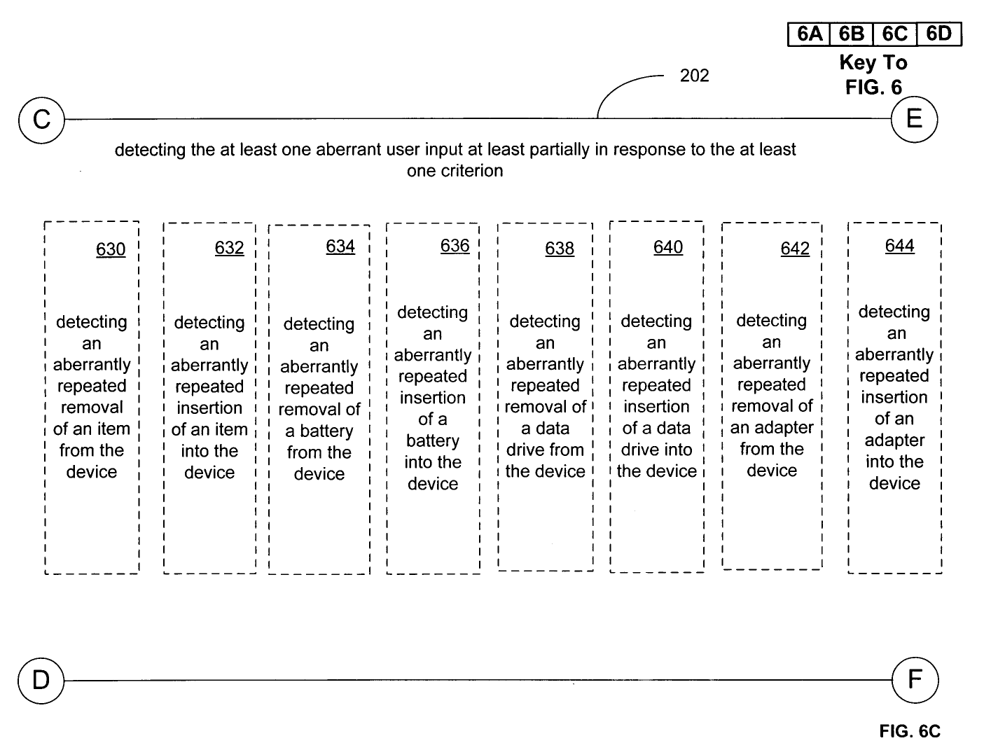

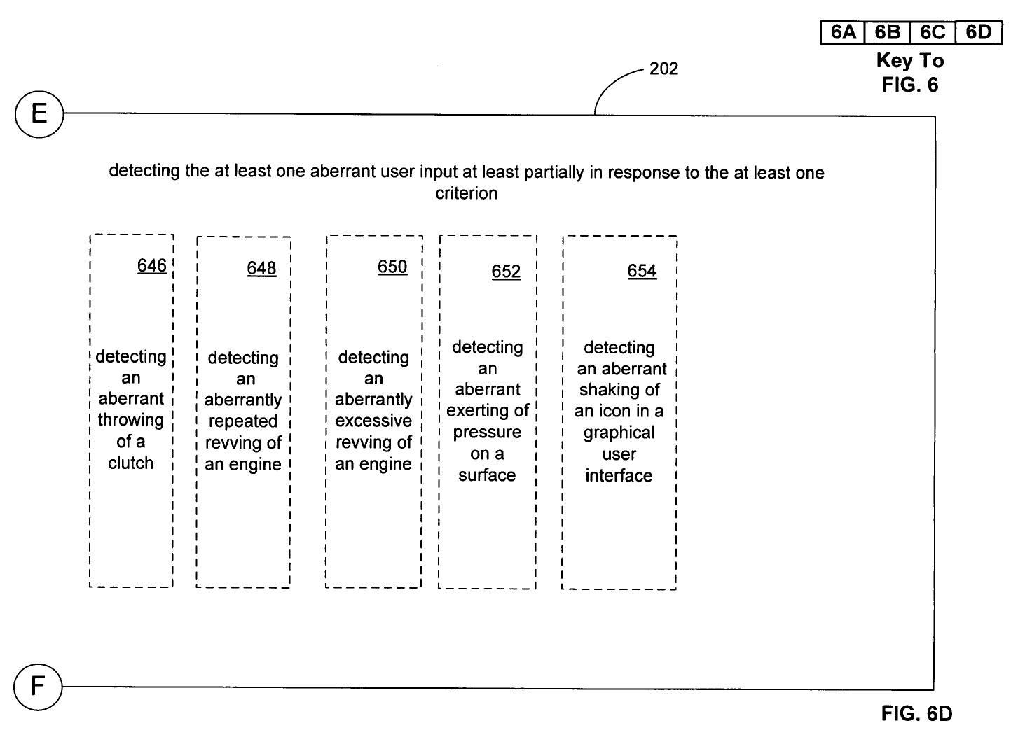

FIG. 6 illustrates alternate implementations of the high-level logic flowchart of FIG. 2. Depicted is that, in various alternative implementations, operation 202—detecting the at least one aberrant user input at least partially in response to the at least one criterion—may include operations 600, 602, 604, 606, 608, 610, 612, 614, 616, 618, 620, 622, 624, 626, 628, 630, 632, 634, 636, 638, 640, 642, 644, 646, 648, 650, 652, and/or 654. Item 600 depicts detecting an aberrant contact with a surface of a device (e.g., detecting the user 100 hitting the steering wheel input device 104 in automobile device 102, or the user 100 kicking a household maintenance device 102 such as a Roomba household maintenance device). Item 602 depicts detecting an aberrant contact with an input device (e.g., detecting the user 100 hitting the mouse input device 104 of a personal computer device 102). Item 604 depicts detecting an aberrant moving of a device (e.g. detecting the user moving a keyboard input device 104 of a desktop computer device 102 up and down in a pounding motion). Item 606 depicts detecting an aberrant shaking of a device (e.g., detecting the user 100 shaking a cell phone device 102). Item 608 depicts detecting an aberrant tipping of a device (e.g., detecting the user 100 lifting a personal computer device 102 by one side to expose a surface not exposed in normal operations). Item 610 depicts detecting an aberrant throwing of a device (e.g., detecting the user 100 throwing a mouse input device of a personal computer device 102 across a room). Item 612 depicts detecting an aberrant impact of a device (e.g., detecting the user 100 throwing a mouse input device of a personal computer device 102 across a room such that it hits a wall). Item 614 depicts detecting an aberrant moving of an item operably coupled to the device (e.g., detecting the user 100 shaking a speaker operably coupled to a personal computer 102). Item 616 depicts detecting an aberrantly repeated use of a mechanical input device (e.g., detecting the user 100 repeatedly pressing a radio button on a radio device 102 in an automobile device 102). Item 618 depicts detecting an aberrant pressure exerted on a mechanical input device (e.g., detecting the user 100 pressing with sustained, excessive pressure on a key of a keyboard input device 104 of a laptop computer 102). Item 620 depicts detecting an aberrant sequential combination of inputs (e.g., detecting the user 100 presses a number of keys on a keyboard input device 104 of a personal computer 102, the key sequence not being assigned a function in the computer's operation). Item 622 depicts detecting an aberrant simultaneous combination of inputs (e.g., detecting the user 100 simultaneously presses a number of keys on a keyboard input device 104 of a personal computer 102, the combination not being assigned a function in the computer's operation). Item 624 depicts detecting an aberrant combination of inputs within a pre-specified period of time (e.g., detecting the user 100 presses within the pre-specified period of 0.5 seconds a number of keys on a keyboard input device 104 of a personal computer 102, the combination not being assigned a function in the computer's operation, such as smashing a keypad with one's fist). Item 626 depicts detecting an aberrantly repeated use of an access door (e.g., detecting the user 100 repeatedly opening and closing the driver's door of an automobile device 102). Item 628 depicts detecting an aberrantly repeated use of an access panel (e.g., detecting the user 100 repeatedly opening and closing the access door of a battery compartment of a cell phone device 102). Item 630 depicts detecting an aberrantly repeated removal of an item from the device (e.g., detecting the user repeatedly removing a flash drive from a receptacle on a personal computer device 102). Item 632 depicts detecting an aberrantly repeated insertion of an item into the device (e.g., detecting the user 100 repeatedly inserts the adapter of a headset into a receptacle of a laptop computer device 102). Item 634 depicts detecting an aberrantly repeated removal of a battery from the device (e.g., detecting the user 100 repeatedly taking a battery out of its compartment in a laptop computer device 102). Item 636 depicts detecting an aberrantly repeated insertion of a battery into the device (e.g., detecting the user 100 repeatedly inserting a battery into its compartment in a laptop computer device 102). Item 638 depicts detecting an aberrantly repeated removal of a data drive from the device (e.g., detecting the user 100 repeatedly taking a data drive out of its compartment in a laptop computer device 102). Item 640 depicts detecting an aberrantly repeated insertion of a data drive into the device (e.g., detecting the user 100 repeatedly inserting a disk drive into its compartment in a laptop computer device 102). Item 642 depicts detecting an aberrantly repeated removal of an adapter from the device (e.g., detecting the user 100 repeatedly taking a speaker adapter out of a receptacle in a personal computer device 102). Item 644 depicts detecting an aberrantly repeated insertion of an adapter into the device (e.g., detecting the user 100 repeatedly inserting a headphone adapter into a receptacle in a laptop computer device 102). Item 646 depicts detecting an aberrant throwing of a clutch (e.g., detecting the user 100 rapidly disengaging the clutch input device 104 of an automobile device 102). Item 648 depicts detecting an aberrantly repeated revving of an engine (e.g., detecting the user 100 repeatedly pressing the accelerator input device 104 of an automobile device 102 to increase engine revolutions repeatedly). Item 650 depicts detecting an aberrantly excessive revving of an engine (e.g., detecting the user 100 pressing the accelerator input device 104 of an automobile device 102 to run an engine above normal operating revolutions). Item 652 depicts detecting an aberrant exerting of pressure on a surface (e.g., detecting the user 100 pressing with sustained, excessive pressure on an exterior surface of a cell phone device 102, such as that applied by squeezing). Item 654 depicts detecting an aberrant shaking of an icon in a graphical user interface (e.g., detecting that the user 100 is using a feature of a graphical user interface of a device 102 to grab and rapidly move back and forth a symbolic icon).

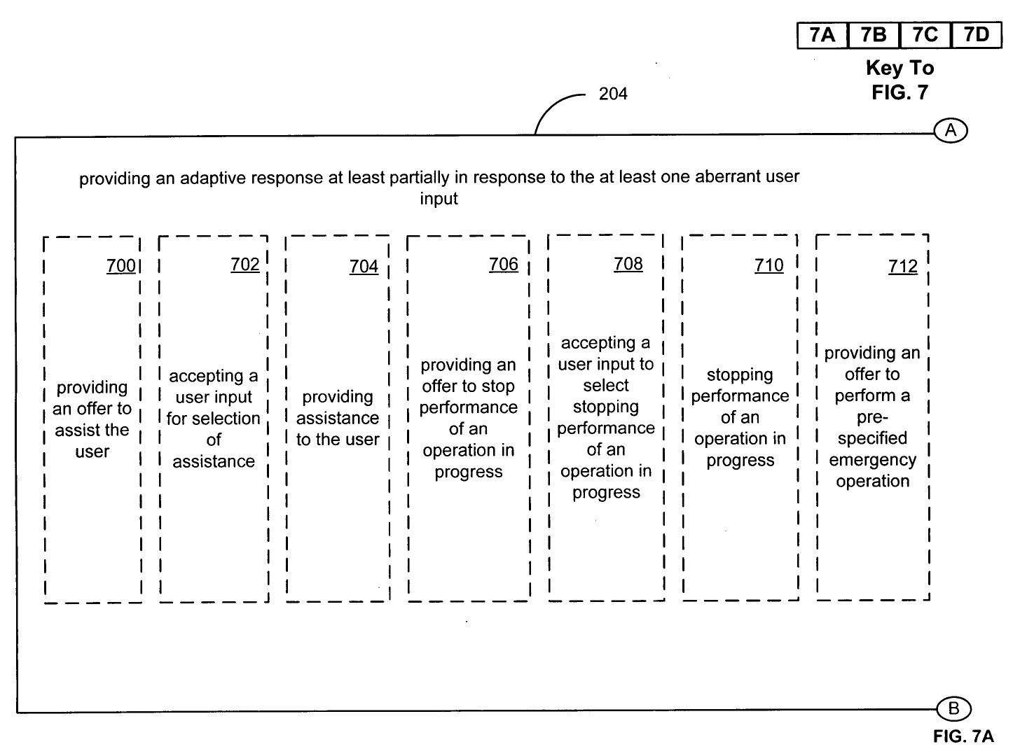

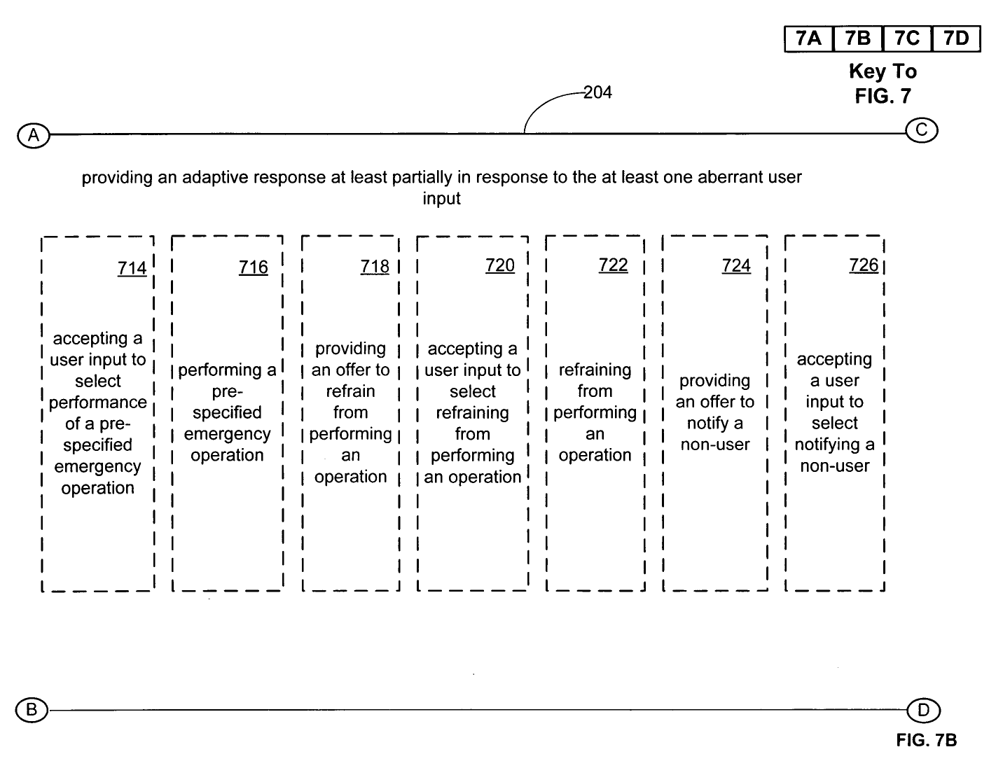

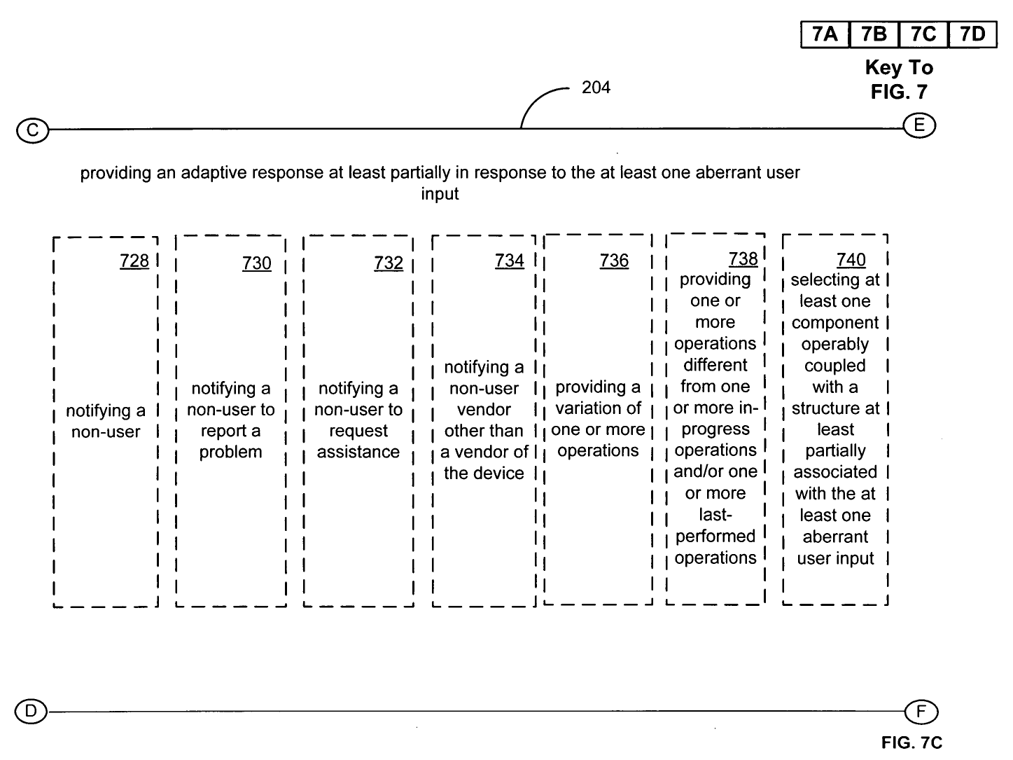

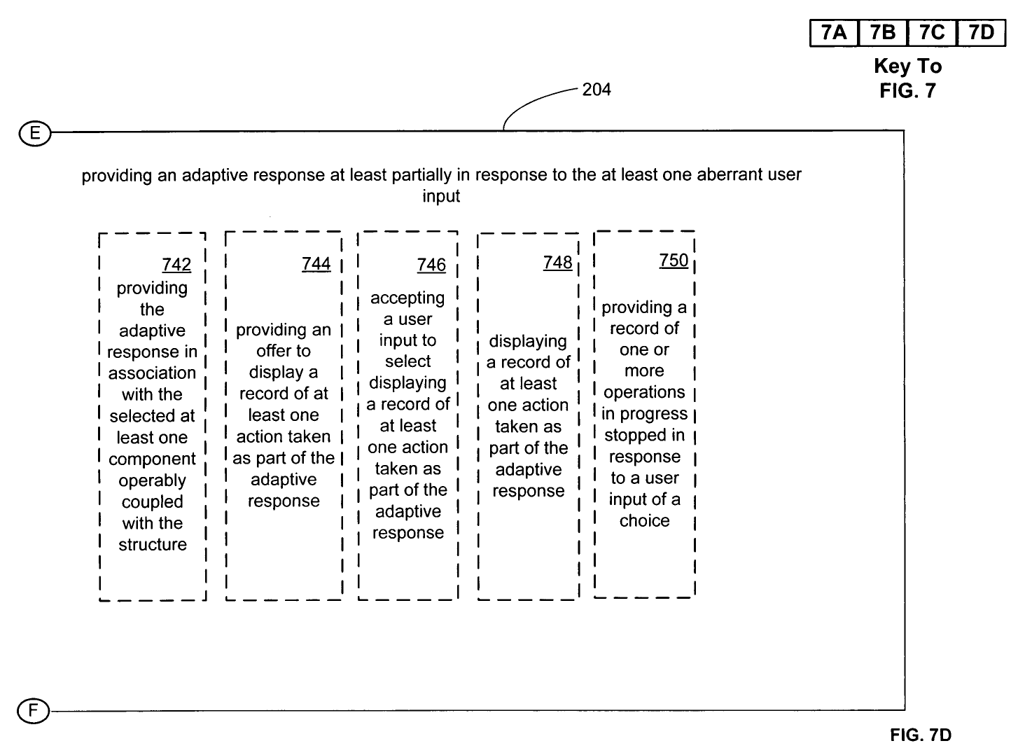

FIG. 7 illustrates alternate implementations of the high-level logic flowchart of FIG. 2. Depicted is that, in various alternative implementations, operation 204—providing an adaptive response at least partially in response to the at least one aberrant user input—may include one or more of operations 700, 702, 704, 706, 708, 710, 712, 714, 716, 718, 720, 722, 724, 726, 728, 730, 732, 734, 736, 738, 740, 742, 744, 746, 748, and/or 750. Depicted is operation 700, providing an offer to assist the user (e.g., the device 102 and/or the input device 104, via text and/or graphics display and/or vocal interaction, asking the user 100 if he needs help). Depicted is operation 702, accepting a user input for selection of assistance (e.g., the device 102 and/or the input device 104, via text and/or graphics display and/or vocal interaction, receiving an input from the user 100 asking for help). Depicted is operation 704, providing assistance to the user (e.g., the device 102 and/or the input device 104, via text and/or graphics display and/or vocal interaction, making a suggestion as to an action the user 100 may want to take in the circumstances). Depicted is operation 706, providing an offer to stop performance of an operation in progress (e.g., the device 102 and/or the input device 104, via text and/or graphics display and/or vocal interaction, presenting to the user 100 an offer to stop one or more operations in progress, and/or presenting to the user 100 a list of one or more operations in progress for selection by the user 100 to be stopped, and/or presenting a menu from which the user 100 may choose to stop one or more operations in progress). Depicted is operation 708, accepting a user input to select stopping performance of an operation in progress (e.g., the device 102 and/or the input device 104, via text and/or graphics display and/or vocal interaction, receiving an input from the user 100 of a choice to stop one or more operations in progress, such as scanning a disk for viruses). Depicted is operation 710, stopping performance of an operation in progress (e.g., the device 102 and/or the input device 104 stopping an operation in progress, such as re-dialing an Internet service provider's telephone number, or the stopping of a household maintenance device 102 such as a Roomba household maintenance device in its motion in the direction in which is moving when kicked by the user 100). Depicted is operation 712, providing an offer to perform a pre-specified emergency operation (e.g., the device 102 and/or the input device 104, via text and/or graphics display and/or vocal interaction, asking the user 100 if an emergency operation pre-specified as a response to the circumstances, such as re-booting a computer, should be performed). Depicted is operation 714, accepting a user input to select performance of a pre-specified emergency operation (e.g., the device 102 and/or the input device 104, via text and/or graphics display and/or vocal interaction, receiving an input from the user 100 commanding performance of an emergency operation pre-specified as response to the circumstances, such as stopping a print job). Depicted is operation 716, performing a pre-specified emergency operation (e.g., the device 102 and/or the input device 104 performing an emergency operation pre-specified for the circumstances, such as terminating telephone contact with an Internet service provider). Depicted is operation 718, providing an offer to refrain from performing an operation (e.g., the device 102 and/or the input device 104, via text and/or graphics display and/or vocal interaction, asking the user 100 if an operation such as updating a webpage in an Internet browser should not be performed). Depicted is operation 720, accepting a user input to select refraining from performing an operation (e.g., the device 102 and/or the input device 104, via text and/or graphics display and/or vocal interaction, receiving from the user 100 a command not to print any remaining print jobs in a print queue). Depicted is operation 722, refraining from performing an operation (e.g., the device 102 and/or the input device 104 not performing a download of updated software over the Internet). Depicted is operation 724, providing an offer to notify a non-user (e.g., the device 102 and/or the input device 104, via text and/or graphics display and/or vocal interaction, asking the user 100 if he wants a non-user such as the vendor of the device 102 and/or the input device 104 notified of the circumstances, i.e., the problem the user 100 has encountered). Depicted is operation 726, accepting a user input to select notifying a non-user (e.g., the device 102 and/or the input device 104, via text and/or graphics display and/or vocal interaction, receiving a command from the user 100 to notify a non-user such as a vendor of a product that competes commercially with the device 102 and/or the input device 104). Depicted is operation 728, notifying a non-user (e.g., the device 102 and/or the input device 104 notifies a non-user such as a problem-reporting center of the problem the user 100 has encountered). Depicted is operation 730, notifying a non-user to report a problem (e.g., the device 102 and/or the input device 104 notifies a non-user such as a problem reporting center via the Internet of the problem the user 100 has encountered). Depicted is operation 732, notifying a non-user to request assistance (e.g., the device 102 and/or the input device 104 notifies a non-user such as a help center via the Internet of the problem the user 100 has encountered). Depicted is operation 734, notifying a non-user vendor other than a vendor of the device (e.g., the device 102 and/or the input device 104 notifies a non-user such as a vendor of a product that competes commercially with the device 102 and/or the input device 104 of the problem the user 100 has encountered so as to inform him of an alternative product). Depicted is operation 736, providing a variation of one or more operations (e.g., the device 102 and/or the input device 104, via text and/or graphics display and/or vocal interaction, providing a variation of an operation in progress and/or an operation performed immediately prior to an operation in progress, such as providing a variation of an in-progress downloading of a webpage with a browser and/or a previous printing of a print job). Depicted is operation 738, providing one or more operations different from one or more in-progress operations and/or one or more last-performed operations (e.g., the device 102 and/or the input device 104, via text and/or graphics display and/or vocal interaction, iterating through a list of different alternative operations as alternatives to one or more operations in progress and to one or more operations performed immediately prior to an operation in progress, such as the alternative operations of running a spreadsheet, streaming an audio program from the Internet, and periodically checking email). Depicted is operation 740, selecting at least one component operably coupled with a structure at least partially associated with the at least one aberrant user input (e.g., the device 102 and/or the input device 104, via text and/or graphics display and/or vocal interaction, such as in an automobile, selecting the last-operated component from among the dashboard-mounted air-conditioning or radio when the user 100 pounds the dashboard, or such as with respect to a stereo cabinet, selecting the last-adjusted component from among the components in the cabinet(e.g., the tuner or the CD player)). Depicted is operation 742, providing the adaptive response in association with the selected at least one component operably coupled with the structure (e.g., a device 102 and/or a, user input device 104, via text and/or graphics display and/or vocal interaction, a device 102 and/or a user input device 104, via text and/or graphics display and/or vocal interaction, providing the adaptive response of switching bands and/or stations on a radio in response to a pounding by the user 100 if the last operation performed before the pounding was tuning the radio, or cycling through air-conditioning options in response to a shout from the user 100 if the last operation performed by the user 100 before the shout was adjusting the air-conditioning, or adjusting the volume of the speaker output of the speakers in a stereo cabinet in response to a kick from the user 100 if the last operation performed before the kick was a volume adjustment, with any of these adaptive responses including requesting approval by the user 100 of the response). Depicted is operation 744, providing an offer to display a record of at least one action taken as part of the adaptive response (e.g., the device 102 and/or the input device 104, via text and/or graphics display and/or vocal interaction, asking the user 100 if he wants a record of actions taken in response to the aberrant user input, such as operations stopped, operations performed, and/or notifications issued). Depicted is operation 746, accepting a user input to select displaying a record of at least one action taken as part of the adaptive response (e.g., the device 102 and/or the input device 104, via text and/or graphics display and/or vocal interaction, receiving from the user 100 a command to provide a record of actions taken in response to the aberrant user input, such as operations stopped, operations performed and/or notifications issued). Depicted is operation 748, displaying a record of at least one action taken as part of the adaptive response (e.g., the device 102 and/or the input device 104 displaying for the user 100 a record of actions taken in response to the aberrant user input, such as operations stopped, operations performed and/or notifications issued). Depicted is operation 750, providing a record of one or more operations in progress stopped in response to a user input of a choice (e.g., a device 102 and/or a user input device 104, via text and/or graphics display and/or vocal interaction, displaying a list of operations stopped at the request of the user 100 by selecting a menu item).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. A system related to user input to a device, the system comprising:
circuitry for providing at least one criterion for at least one aberrant user input;
circuitry for detecting the at least one aberrant user input at least partially in response to the at least one criterion; and
circuitry for providing an adaptive response at least partially in response to the at least one aberrant user input.

67. A system comprising:
means for providing at least one criterion for at least one aberrant user input;
means for detecting the at least one aberrant user input at least partially in response to the at least one criterion; and
means for providing an adaptive response at least partially in response to the at least one aberrant user input.

68. A system having a program product, said program product comprising:
a signal bearing medium bearing at least one of
one or more instructions for providing at least one criterion for at least one aberrant user input,
one or more instructions for detecting the at least one aberrant user input at least partially in response to the at least one criterion, and
one or more instructions for providing an adaptive response at least partially in response to the at least one aberrant user input.

69. (canceled)

70. (canceled)

71. The program product of claim 68, wherein the one or more instructions for providing at least one criterion for at least one aberrant user input further comprises:
one or more instructions for providing a criterion for an aberrant mechanical input.

72. The program product of claim 71, wherein the one or more instructions for providing a criterion for an aberrant mechanical input further comprises:
one or more instructions for providing a criterion for an aberrant intensity mechanical input.

73. The program product of claim 71, wherein the one or more instructions for providing a criterion for an aberrant mechanical input further comprises:
one or more instructions for providing a criterion for an aberrant frequency mechanical input.

74. (canceled)

75. (canceled)

76. The program product of claim 68, wherein the one or more instructions for providing at least one criterion for at least one aberrant user input further comprises:
one or more instructions for providing a criterion for an aberrant sonic input.

77. The program product of claim 76, wherein the one or more instructions for providing a criterion for an aberrant sonic input further comprises:
one or more instructions for providing a criterion for an aberrant intensity sonic input.

78. (canceled)

79. (canceled)

80. (canceled)

81. The program product of claim 76, wherein the one or more instructions for providing a criterion for an aberrant sonic input further comprises:
one or more instructions for providing a criterion for an aberrant content sonic input.

82. The program product of claim 68, wherein the one or more instructions for detecting the at least one aberrant user input at least partially in response to the at least one criterion further comprises:
one or more instructions for detecting an aberrant contact with a surface of a device.

83. The program product of claim 68, wherein the one or more instructions for detecting the at least one aberrant user input at least partially in response to the at least one criterion further comprises:
one or more instructions for detecting an aberrant contact with an input device.

84. The program product of claim 68, wherein the one or more instructions for detecting the at least one aberrant user input at least partially in response to the at least one criterion further comprises:
one or more instructions for detecting an aberrant moving of a device.

85. The program product of claim 68, wherein the one or more instructions for detecting the at least one aberrant user input at least partially in response to the at least one criterion further comprises:
one or more instructions for detecting an aberrant shaking of a device.

86. (canceled)

87. The program product of claim 68, wherein the one or more instructions for detecting the at least one aberrant user input at least partially in response to the at least one criterion further comprises:
one or more instructions for detecting an aberrant throwing of a device.

88. The program product of claim 68, wherein the one or more instructions for detecting the at least one aberrant user input at least partially in response to the at least one criterion further comprises:
one or more instructions for detecting an aberrant impact of a device.

89. The program product of claim 68, wherein the one or more instructions for detecting the at least one aberrant user input at least partially in response to the at least one criterion further comprises:
one or more instructions for detecting an aberrant moving of an item operably coupled to the device.

90. The program product of claim 68, wherein the one or more instructions for detecting the at least one aberrant user input at least partially in response to the at least one criterion further comprises:
one or more instructions for detecting an aberrantly repeated use of a mechanical input device.

91. The program product of claim 68, wherein the one or more instructions for detecting the at least one aberrant user input at least partially in response to the at least one criterion further comprises:
one or more instructions for detecting an aberrant pressure exerted on a mechanical input device.

92. The program product of claim 68, wherein the one or more instructions for detecting the at least one aberrant user input at least partially in response to the at least one criterion further comprises:
one or more instructions for detecting an aberrant sequential combination of inputs.

93. The program product of claim 68, wherein the one or more instructions for detecting the at least one aberrant user input at least partially in response to the at least one criterion further comprises:
one or more instructions for detecting an aberrant simultaneous combination of inputs.

94. The program product of claim 68, wherein the one or more instructions for detecting the at least one aberrant user input at least partially in response to the at least one criterion further comprises:
one or more instructions for detecting an aberrant combination of inputs within a pre-specified period of time.

95. The program product of claim 68, wherein the one or more instructions for detecting the at least one aberrant user input at least partially in response to the at least one criterion further comprises:
one or more instructions for detecting an aberrantly repeated use of an access door.

96. (canceled)

97. The program product of claim 68, wherein the one or more instructions for detecting the at least one aberrant user input at least partially in response to the at least one criterion further comprises:
one or more instructions for detecting an aberrantly repeated removal of an item from the device.

98. The program product of claim 68, wherein the one or more instructions for detecting the at least one aberrant user input at least partially in response to the at least one criterion further comprises:
one or more instructions for detecting an aberrantly repeated insertion of an item into the device.

99. (canceled)

100. (canceled)

101. (canceled)

102. (canceled)

103. (canceled)

104. (canceled)

105. (canceled)

106. The program product of claim 68, wherein the one or more instructions for detecting the at least one aberrant user input at least partially in response to the at least one criterion further comprises:
one or more instructions for detecting an aberrantly repeated revving of an engine.

107. The program product of claim 68, wherein the one or more instructions for detecting the at least one aberrant user input at least partially in response to the at least one criterion further comprises:
one or more instructions for detecting an aberrantly excessive revving of an engine.

108. The program product of claim 68, wherein the one or more instructions for detecting the at least one aberrant user input at least partially in response to the at least one criterion further comprises:
one or more instructions for detecting an aberrant exerting of pressure on a surface.

109. (canceled)

110. The program product of claim 68, wherein the one or more instructions for providing an adaptive response at least partially in response to the at least one aberrant user input further comprises:
one or more instructions for providing an offer to assist the user.

111. (canceled)

112. The program product of claim 68, wherein the one or more instructions for providing an adaptive response at least partially in response to the at least one aberrant user input further comprises:
one or more instructions for providing assistance to the user.

113. The program product of claim 68, wherein the one or more instructions for providing an adaptive response at least partially in response to the at least one aberrant user input further comprises:
one or more instructions for providing an offer to stop performance of an operation in progress.

114. (canceled)

115. (canceled)

116. The program product of claim 68, wherein the one or more instructions for providing an adaptive response at least partially in response to the at least one aberrant user input further comprises:
one or more instructions for providing an offer to perform a pre-specified emergency operation.

117. (canceled)

118. The program product of claim 68, wherein the one or more instructions for providing an adaptive response at least partially in response to the at least one aberrant user input further comprises:
one or more instructions for performing a pre-specified emergency operation.

119. The program product of claim 68, wherein the one or more instructions for providing an adaptive response at least partially in response to the at least one aberrant user input further comprises:
one or more instructions for providing an offer to refrain from performing an operation.

120. (canceled)

121. The program product of claim 68, wherein the one or more instructions for providing an adaptive response at least partially in response to the at least one aberrant user input further comprises:
one or more instructions for refraining from performing an operation.

122. The program product of claim 68, wherein the one or more instructions for providing an adaptive response at least partially in response to the at least one aberrant user input further comprises:
one or more instructions for providing an offer to notify a non-user.

123. (canceled)

124. The program product of claim 68, wherein the one or more instructions for providing an adaptive response at least partially in response to the at least one aberrant user input further comprises:
one or more instructions for notifying a non-user.

125. The program product of claim 68, wherein the one or more instructions for providing an adaptive response at least partially in response to the at least one aberrant user input further comprises:
one or more instructions for notifying a non-user to report a problem.

126. The program product of claim 68, wherein the one or more instructions for providing an adaptive response at least partially in response to the at least one aberrant user input further comprises:
one or more instructions for notifying a non-user to request assistance.

127. The program product of claim 68, wherein the one or more instructions for providing an adaptive response at least partially in response to the at least one aberrant user input further comprises:
one or more instructions for notifying a non-user vendor other than a vendor of the device.

128. The program product of claim 68, wherein the one or more instructions for providing an adaptive response at least partially in response to the at least one aberrant user input further comprises:
one or more instructions for providing a variation of one or more operations.

129. The program product of claim 68, wherein the one or more instructions for providing an adaptive response at least partially in response to the at least one aberrant user input further comprises:
one or more instructions for providing one or more operations different from one or more in-progress operations and/or one or more last-performed operations.

130. The program product of claim 68, wherein the one or more instructions for providing an adaptive response at least partially in response to the at least one aberrant user input further comprises:
one or more instructions for selecting at least one component operably coupled with a structure at least partially associated with the at least one aberrant user input; and
one or more instructions for providing the adaptive response in association with the selected at least one component operably coupled with the structure.

131. The program product of claim 68, wherein the one or more instructions for providing an adaptive response at least partially in response to the at least one aberrant user input further comprises:
one or more instructions for providing an offer to display a record of at least one action taken as part of the adaptive response.

132. (canceled)

133. The program product of claim 68, wherein the one or more instructions for providing an adaptive response at least partially in response to the at least one aberrant user input further comprises:
one or more instructions for displaying a record of at least one action taken as part of the adaptive response.

134. The program product of claim 68, wherein the one or more instructions for providing an adaptive response at least partially in response to the at least one aberrant user input further comprises:
one or more instructions for providing a record of one or more operations in progress stopped in response to a user input of a choice.
